(19) United States
(12) Patent Application Publication
(10) Pub. No.: US 2009/0260700 A1
(43) Pub. Date: Oct. 22, 2009

(54) 3-Port Directional Control Valve

(76) Inventor: Andre-Heinrich Meinhof, Rheinstetten (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/989,338

(22) PCT Filed: Jul. 25, 2006
(86) PCT No.: PCT/EP2006/064650

§ 371 Date: Jan. 24, 2008

(30) Foreign Application Priority Data
Aug. 1, 2005 (DE) 10 2005 036 059.9

(51) Int. Cl. F16K 11/14

(52) U.S. Cl. 137/625

(57) ABSTRACT

There is described a 3-port directional control valve having a first valve chamber, a second valve chamber and a third valve chamber, wherein a first fluid passage, which can be closed off by means of a first adjustable valve body, is provided between the first valve chamber and the second valve chamber, and a second fluid passage, which can be closed off by means of a second adjustable valve body, is provided between the second valve chamber and the third valve chamber. The first valve body and the second valve body are arranged on an actuating element which is mounted so as to be rotatable about at least one rotational axis, so that the adjusting movements of the valve bodies take place in opposition to one another. A diaphragm is arranged between the valve bodies, and the actuating element, herein the effective area of the diaphragm is matched to the effective cross section of the respective valve body for the purpose of force equalization.

### CROSS REFERENCE TO RELATED APPLICATIONS

This application is the US National Stage of International Application No. PCT/EP2006/064650, filed Jul. 25, 2006 and claims the benefit thereof. The International Application claims the benefits of German application No. 10 2005 036 059.9 DE filed Aug. 01, 2005, both of the applications are incorporated by reference herein in their entirety.

### FIELD OF INVENTION

The invention relates to a 3-port directional control valve having a first valve chamber, a second valve chamber and a third valve chamber, with a first fluid passage, which can be closed off by means of a first adjustable valve body, being present between the first valve chamber and the second valve chamber and a second fluid passage, which can be closed off by means of a second adjustable valve body, being present between the second valve chamber and the third valve chamber.

### BACKGROUND OF INVENTION

A 3-port directional control valve of this type is known for example from DE 42 01 442 A1. With the known 3-port directional control valve two valve bodies are arranged on a rod-type slide adjustable in an axial direction. The slide can be used to bring the valve bodies into a valve seat, which then closes off a relevant fluid passage. The valve bodies or the valve seats respectively are arranged so that, during an adjustment of the slide, one valve body is moved towards its associated valve seat and the other valve body is moved away from its associated valve seat. The adjustment of the slide in one direction thus allows one fluid passage to be opened while the other fluid passage is closed.

The valve bodies are fastened to the slide in a sprung manner. This allows both fluid passages to be closed for a particular position of the slide. Depending on the slide position, one valve body, the other valve body or both valve bodies therefore sit in their relevant valve seat or in their valve seats respectively.

The disadvantage with the said valve is that the valve bodies also react in different ways to acceleration forces acting on the valve. It is thus possible for example for an acceleration force acting on the valve to push the one valve body into its valve seat and for the other valve body to be lifted at least temporarily out of its valve seat. This means that the other valve body at least temporarily no longer sits firmly in its valve seat. A similar situation can also arise as a result of a temperature-induced length change in the slide. This is because a change in the length of the slide can cause the one valve body to move towards its valve seat but causes the other valve body to move away out of its valve seat.

A valve arrangement consisting of two 3-port directional control valves which has three valve chambers is known from DE 8 713 904 U1. Between the first and the second valve chamber is a fluid passage which can be closed off by a first valve body. Likewise a fluid passage able to be closed off by the second valve body is provided between the second and the third valve chamber. The two valve bodies are arranged on an actuation element supported to allow rotation around least one axis of rotation. The adjustment movements of the valve bodies occur in opposite directions.

The actuator rods are embodied as a pistons guided in a bore. The guidance of the pistons in the bores enables a degree of sealing of the valve chambers to be achieved. Furthermore the actuation rods feature an opposingly arranged annular surface at a distance from their valve seat surface to which air pressure can be applied. The annular surface is embodied around 25 percent larger than the valve seat surface. This produces a resulting force in the closure direction of the valve.

A 3-port directional control valve is known from DE 1 140 417 B of which the valve body is spring-loaded in the closing direction. The springs are arranged outside the valve chambers.

Furthermore a 3-port directional control valve is known from U.S. Pat. No. 2,647,536 in which two valve bodies arranged at a distance from one another run in parallel to each other. The two valve bodies are arranged on an actuation element which is articulated in each case at the ends of the valve body.

In addition a 3-port directional control valve is known from DE 652105 328 38 C in which valve bodies adjustable on a common axis are connected via a connecting link to a rotatable actuation element.

Furthermore a 3-port directional control valve is known from DE 1 852 663 U in which the valve bodies are likewise able to be adjusted on a common axis. A roller is provided for actuation of the valve bodies which pushes on the push rods of the valve bodies. The surfaces of the push rods facing towards the respective pressure chamber correspond to the surfaces of the valve bodies facing towards the respective pressure chamber, which equalizes the pressures of the valves in relation to their pressure chambers.

A valve arrangement consisting of two 3-port directional control valves which is used to control a two-chamber actuator is known from U.S. Pat. No. 1,486,304. The springs of the valve bodies lie outside the valve chambers.

A multi-port directional control valve actuated by two pistons is known from DE 101 09 206 A1. The two valve bodies are coupled by a rocker.

In addition a lifting valve is known from GB 1010721 in which a separation element is embodied as a membrane.

### SUMMARY OF INVENTION

An object of the invention is to embody an aforementioned 3-port directional control valve such that it is less sensitive to faults.

The solution to this problem emerges from the features of the characterizing part of an independent claim. Advantageous developments of the invention emerge from the subclaims.

In accordance with the invention a 3-port directional control valve for activation of a pneumatically-actuatable two-chamber control is specified, with a first valve chamber, a second valve chamber and a third valve chamber, with a first fluid passage being present between the first valve chamber and the second valve chamber, which is able to be closed off by means of a first adjustable valve body and a second fluid passage being present between the second valve chamber and the third valve chamber is which is able to be closed off by means of a second adjustable valve body, with the first valve body and the second valve body being arranged around an actuation element able to be rotated around at least one axis of rotation, so that the adjustment movements of the valve body occur in opposing directions, wherein a membrane is arranged between the valve bodies and the actuation element, with the active surface of the membrane being tailored for equalizing the forces to the active cross-section of the respective valve body.

The inventive 3-port directional control valve is excellently well suited to use as a booster for the operating chamber of an electro-pneumatic control valve. Thus for example is can be used for direct activation of a pneumatically-actuatable 2-chamber actuator, as is known for example from EP 0 918 939 B1.

The fact that the first valve body and the second valve body are arranged on an actuation element rotatably supported around an axis of rotation, so that the adjustment movements of the valve body occur in opposing directions, allows the two valve bodies to be arranged at a distance from each other roughly in parallel, as is provided for in a particular embodiment of the invention. This means that the two valve bodies, to open or close their fluid passages, undertake a movement in the same direction. This means that external forces operating on the valve act on both bodies in the same way.

If an external acceleration force is acting on the 3-port directional control valve which has a direction whereby both valve bodies are lifted out of their valve seats, then the valve bodies exert a force acting in the same direction on the rotatably supported actuation element in each case. The forces compensate for each other. Thus in an advantageous embodiment of the invention there is provision for the axis of rotation to lie between the first valve body and the second valve body. Provided the axis of rotation lies in the center between the two valve bodies, the forces cancel each other out completely.

The same also applies to mechanical tolerances and temperature influences. These have practically no effects since they essentially compensate for each other. This is because, since any mechanical changes which may occur, act in the same way on both valve bodies, the influence on the rotatably-supported actuation element on both sides of the axis of rotation is likewise the same, which compensates for the influences.

Instead of one axis of rotation however there can also be two axes of rotation, which respectively lie at the point at which the relevant valve body is connected to the actuation element. The result of this is that, although no compensation from outside is achieved via the actuation element for external acceleration forces acting on the valve body, the advantage is gained instead that almost any possible mechanical play of the elements for actuating the valve body is excluded.

The great advantage of the inventive 3-port directional control valve is that a membrane is arranged between the valve body and the actuation element. The advantage offered by the membrane is that the actuation element is located outside the valve chamber. This is very advantageous since this means that the actuation element does not come into contact with the medium conducted through the valve, which for example avoids the actuation element becoming corroded.

Furthermore it is very advantageous that the active surface of the membrane is matched to the active cross-section of the respective valve body. The result of this is that the force which is exercised on the valve body as a result of the pressure obtaining in the valve chambers is compensated for. This is because the pressure acting on the relevant membrane acts in the opposite direction to the force acting on the relevant valve body. The function of the valve body or of the valve respectively is thus not adversely affected by the pressure obtaining in the valve chamber.

An embodiment of the invention has proved advantageous in which spring elements are present, by means of which a force is exercised on the valve body in the closure direction of the valve body. This guarantees a reliable closure of the fluid passages. It is very advantageous in this embodiment for the spring elements to be separated from the valve chambers by a separation element. The separation element, which can also be embodied as a membrane, prevents the relevant spring element from coming into contact with the medium conducted through the valve.

Furthermore the use of separation elements result in the valve chambers forming a flow area with a simple geometry, since there are no elements to impede the flow within the flow area. All functional elements required for the control of the valve are located outside the flow area, so that they are easily accessible and are not influenced by the flow of media.

### BRIEF DESCRIPTION OF THE DRAWINGS

Further details, features and advantages of the present invention emerge from the description given below of a particular exemplary embodiment which refers to the drawing.

The figures show

FIG. 1 a schematic diagram of a first embodiment of an inventively embodied 3-port directional control valve,

FIG. 2 a schematic diagram of a second embodiment of an inventively embodied 3-port directional control valve, and

FIG. 3 a schematic diagram of a third embodiment of an inventively embodied 3-port directional control valve

### DETAILED DESCRIPTION OF INVENTION

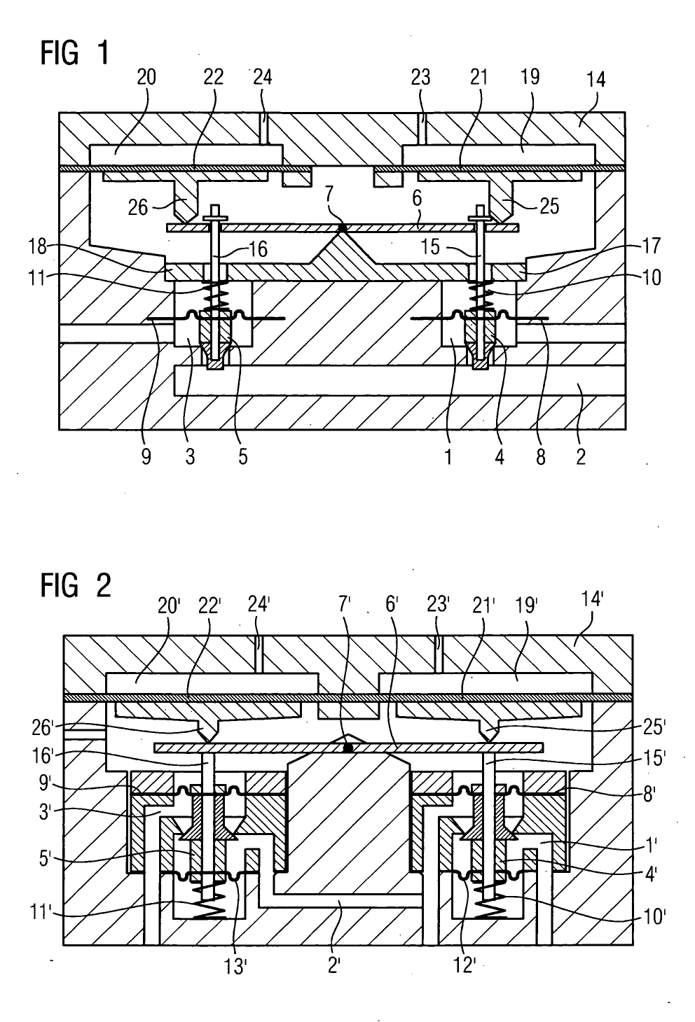

As can be seen from FIG. 1, a first valve chamber 1, a second valve chamber 2 and a third valve chamber 3 are arranged in a chassis unit 14. The valve chambers 1, 2, 3 each have a supply line leading out of the chassis unit 14.

The first valve chamber 1 is connected via a first fluid passage to the second valve chamber 2. The third valve chamber 3 is connected via a second fluid passage to the second valve chamber 2. Arranged in the first valve chamber 1 is a first adjustable valve body 4, in an essentially cylindrical embodiment. The first valve body 4 can be axially displaced so that the first fluid passage is able to be closed off by it. To this end the first fluid passage has a first valve seat, onto which the first valve body 4 can be moved. If the first valve body 4 is seated on the first valve seat, the first fluid passage is closed. The valve seat is embodied in a conventional manner, which is why it is not shown separately in FIG. 1.

In the same way as the first valve chamber 1, a second, essentially cylindrically embodied valve body 5 is arranged in the third valve chamber 3. The second valve body 5 is likewise axially displaceable, so that the second fluid passage is able to be closed off by means of it. To this end the second fluid passage features a second valve seat, onto which the second valve body 5 is able to be moved. If the second valve body 5 is seated in the second valve seat, the second fluid passage is closed. The second valve seat is likewise embodied in a conventional manner so that it is also not shown separately in FIG. 1.

The first valve body 4 features a first actuation rod 15. The second valve body 5 features a second actuation rod 16. The first actuation rod 15 as well as the second actuation rod 16 are connected at their ends facing away from the valve bodies 4 or 5 to an actuation element 6 embodied in the shape of a fishplate. The actuation element 6 is supported in its center between the actuation rods 15, 16 to allow rotation around an axis of rotation 7. Through this the valve bodies 4, 5 are arranged on a centrally supported rocker.

The connection of the actuation rods 15, 16 to the actuation element 6 is such that, for a movement of one arm of the actuation element 6 in the direction away from a relevant valve body 4, 5, the relevant actuation rod 15, 16 or the relevant valve body 5 respectively, is taken with it, and for a movement of the actuation element 6 in the direction of a relevant valve body 4, 5, the relevant actuation rod 16 or the relevant valve body 5 is not taken with it. This means that, for a movement of one arm of the actuation element 6 in the direction of a valve body 4, 5, the arm of the actuation element 6 slides on the relevant actuation rod 15, 16.

A first membrane 8 forming a first separation element extends through the first valve chamber 1. The first membrane 8 closes off the first valve chamber 1 tightly, which separates the actuation element 6 from the first valve chamber 1. The first valve body 4 extends through the first membrane 8, but forms a tight seal with the first membrane 8.

On the end of the first valve body 4 facing away from the first valve seat a first compression spring 10 is arranged outside the first valve chamber 1 between the first valve body 4 and a first stop element 17 of the chassis unit 14. The first compression spring 10 is dimensioned so that the first valve body 4, for a horizontal position of the actuation element 6 is pushed with a light force into the valve seat, so that a secure closure of the first fluid passage is guaranteed.

A second membrane 9 forming a separation element extends through the third valve chamber 3. The second membrane 9 seals off the third valve chamber 3 tightly which means that the actuation element is located outside the third valve chamber. The second valve body 5 extends through the second membrane 9, but forms a tight seal with the second membrane 9.

On the end of second first valve body 5 facing away from the second valve seat a second compression spring 11 is arranged outside the third valve chamber 3 between the second valve body 5 and a second stop element 18 of the chassis unit 14. The second compression spring 11 is dimensioned so that the second valve body 5 for a horizontal position of the actuation element 6 is pressed with a light force into the valve seat, so that a secure closure of the second fluid passage is guaranteed.

Since the first membrane 8 tightly closes off the first valve chamber 1 the first compression spring 8 is located outside the first valve chamber 1. In the same way the second compression spring 11 is located outside the third valve chamber 3. This means that the compression springs 10, 11 do not come into contact with the medium conducted through the valve. This is especially very advantageous with an aggressive medium.

The chassis unit 14 further features a first pressure chamber 19 and a second pressure chamber 20. The first pressure chamber 19 is closed off by means of a third membrane 21 and features a first connection 23. The second pressure chamber

20 is closed of by means of a fourth membrane 22 and features a second connection 24. On the side facing away from the first pressure chamber 19 a first pin 25 is arranged on the third membrane 21 which is effectively connected to the actuation element 6. In the same way a second pin 26 is arranged on the side of the fourth membrane 21 facing away from the pressure chamber 20 which is effectively connected to the actuation element 6.

If a pressure is generated via the first connection 23 in the first pressure chamber 19, the third membrane 21 curves outwards, so that the first pin 25 moves towards the first valve body 4. Since the first actuation rod 15 does not form an interference fit in this direction with the actuation element 6, which means that the actuation element 6 slides on the first actuation rod 15, the actuation element 6 at this point will also be moved towards the first valve body 4.

The fact that the actuation element 6 is supported in the center between the first valve body 4 and the second valve body 5 means that the actuation element 6 is moved away from the second valve body 5 on the side opposite to the first valve body 4. This curves the fourth membrane 22 via the second pin 26 into the second pressure chamber 20. If the second connection 24 is opened no pressure builds up in the second pressure chamber 20 and thus there is no opposing force.

The movement of the actuation element 6 away from the second valve body 5 causes the second valve body 5 to lift out of its valve seat, which opens the second fluid passage. The third valve chamber 3 can be evacuated in this way for example.

If on the other hand pressure is applied via the second connection 24 to the second pressure chamber 20, the fourth membrane 22 curves outwards, so that the second pin 26 moves towards the second valve body 5. Since the second actuation rod 16 does not form an interference fit in this direction with the actuation element 6, meaning that the actuation element 6 slides on the second actuation rod 16, the actuation element 6 at this point will also be moved towards the second valve body 5.

The fact that the actuation element 6 is supported in the center between the first valve body 4 and the second valve body 5 means that the actuation element 6 is moved away from the first valve body 5 on the side opposite to the second valve body 4. This curves the third membrane 21 via the first pin 25 into the first pressure chamber 19. If the first connection 23 is opened no pressure builds up in the first pressure chamber 19 and thus there is no opposing force.

The movement of the actuation element 6 away from the first valve body 4 causes the first valve body 4 to lift out of its valve seat, which opens the first fluid passage. This for example enables a medium conducted in the first valve chamber 1 to get into the second valve chamber 2, with the pressure in the second valve chamber 2 corresponding to the pressure in the first valve chamber 1.

The design of an inventively embodied 3-port directional control valve shown in FIG. 2 essentially corresponds to the embodiment shown in FIG. 1. The same elements thus have the same reference symbols; but to distinguish between them they are provided with a single quotation mark.

The essential difference between the embodiment shown in FIG. 2 and the embodiment shown in FIG. 1 lies in the fact that, by a movement of the actuation element 6′ in the direction of a relevant valve body 4′, 5′, the relevant valve body 4′, 5′ is lifted out of an associated valve seat, which opens the relevant fluid passage. This enables the actuation rods 15′, 16′ to have a fixed connection to the actuation element.

Furthermore a fifth membrane 12′ forming a separation element extends through the first pressure chamber 1′ which tightly seals off the first valve chamber 1′. The first valve body 4′ extends through the fifth membrane 12′, but forms a tight seal with the fifth membrane 12′.

At the end of the first valve body 4′ facing away from the first valve seat a first compression spring 10′ is arranged outside the first valve chamber 1′ between the first valve body 4′ and the chassis unit 14′. The first compression spring 10′ is dimensioned so that the first valve body 4′, with a horizontal position of the actuation element 6′ is pressed with a light force into the valve seat, so that a secure closure of the first fluid passage is guaranteed.

Furthermore a sixth membrane 13′ forming a separation element extends through the third valve chamber 3′, which tightly seals off the third valve chamber 3′. The second valve body 5′ extends through the sixth membrane 13′, but forms a tight seal with the sixth membrane 13′.

On the end of second first valve body 5′ facing away from the second valve seat a second compression spring 11′ is arranged outside the third valve chamber 3′ between the second valve body 5′ and the chassis 14′. The second compression spring 11′ is dimensioned so that the second valve body 5′ in a horizontal position of the actuation element 6′ is pressed with a light force into the valve seat, so that a secure closure of the fluid passage is guaranteed.

The particular advantage of the embodiment shown in FIG. 2 is that the effective surfaces of the separation elements 8′, 9′, 12′, 13′ are tailored to the effective cross-section of the respective valve body 4′, 5′. This means for example, for the first valve chamber 1′ and the relevant elements 4′, 8′, 9′, 12′, 13′, that the force which acts as a result of the pressure obtaining in the first valve chamber 1′ on the first valve body 4′ in the direction of the first valve seat is almost exactly as great as the force which acts on the fifth membrane 12′ in the direction away from the first valve seat as a result of the pressure obtaining in the first valve chamber 1′. In other words, the effective surface of the valve body 4′ for the generation of the force in the direction of the valve seat for the pressure in the valve chamber 1′ is almost exactly as great as the effective surface of the membrane 8′ for the generation of the force in the direction away from the valve seat for the pressure in the valve chamber 1′.

The same applies to the second valve chamber 2′ and the associated elements as well as to the third valve chamber 3′ and the relevant respective elements.

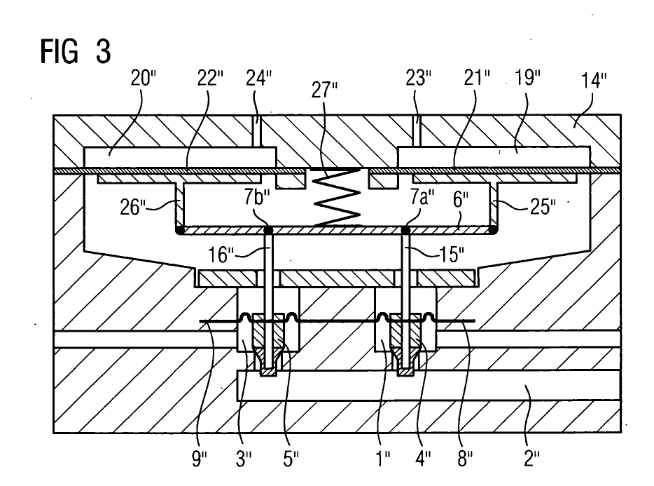

The design of a inventively embodied 3-port directional valve shown in FIG. 3 likewise essentially corresponds to the embodiment shown in FIG. 1. The same elements thus have the same reference symbols; but to distinguish between them they are followed by double quotation marks.

The major difference between the embodiment shown in FIG. 3 and that shown in FIG. 1 lies in the fact that the actuation element 6″ does not just have one axis of rotation but has two axes of rotation 7a″, 7b″. The axes of rotation 7a″, 7b″ are each located at the connecting point between the relevant valve body 4″, 5″ or the relevant actuation rod 15″, 16″ respectively and the actuation element 6″. In an advantageous manner this results in the elimination of almost any possible play in the mechanical construction.

As can be seen from FIG. 3, the first actuation rod 15″ is connected to the actuation element 6″ to allow rotation around the first axis of rotation 7a″. The second actuation rod 16″ is connected to the actuation element 6″ to allow rotation around the first axis of rotation 7a″. The actuation element 6″ is connected in the center between the two axes of rotation 7a″, 7b″ via a third spring 27″ to the chassis unit 14″.

If a pressure is generated via the first connection 23″ in the first pressure chamber 19″, the third membrane 21″ curves outwards, so that the first pin 25″ moves towards the first valve body 4″. This action likewise moves the actuation element 6″, at the point at which the first pin 25″ meets the actuation element 6″, towards the first valve body 4″.

Since the first valve body 4″ is seated in its valve seat, the first actuation rod 15″ does not move downwards, which causes the actuation element 6″ to rotate around the first axis of rotation 7a″. This means that the second actuation rod 16″ or the second valve body 4″ respectively is moved in a direction away from the second valve seat, which opens the second fluid passage.

The same occurs if pressure is applied via the second connection 24″ to the second pressure chamber 20″.

The fourth membrane 22″ then curves outwards, so that the second pin 26″ moves towards the second valve body 5″. This action likewise moves the actuation element 6″ at the point at which the second pin 26″ hits the actuation element 6″ towards the second valve body 5″.

Since the second valve body 5″ is seated in its valve seat, the second actuation rod 16″ does not move downwards, which causes the actuation element 6″ to rotate around the second axis of rotation 7b″. This means that the first actuation rod 15″ or the first valve body 4″ respectively are moved away from the first valve seat, which opens the first fluid passage.

The third compression spring 27″ is arranged in the center of the actuation element 6″ between the actuation element 6″ and the chassis unit 14″. The third compression spring 27″ is dimensioned so that the two valve bodies 4″, 5″ in the horizontal position of the actuation element 6″ are pressed with a light force onto their valve seat, so that a secure closure of the fluid passage is guaranteed.

1.-6. (canceled)

7. A 3-port directional control valve for activation of a pneumatically-actuatable two-chamber actuator, comprising:
a first valve chamber;
a second valve chamber;
a third valve chamber;
a first fluid passage;
a first adjustable valve body to close off the first fluid passage;
a second fluid passage;
a second adjustable valve body to close off the second fluid passage;
an actuation element with an axis of rotation, wherein the first adjustable valve body and the second adjustable valve body are physically connected with the actuation element so that adjustment movements of the adjustable valve bodies are opposite to each other; and
a membrane to separate at least one chamber from the actuation element.

8. The 3-port directional control valve as claimed in claim 7, wherein the membrane is between the valve bodies and the actuation element.

9. The 3-port directional control valve as claimed in claim 8, wherein based upon an effective surface of the membrane forces to an affective cross-section of the respective valve body are equalized.

10. The 3-port directional control valve as claimed in claim 9, wherein the opposite movements of the adjustable valve bodies occur in opposing directions.

11. The 3-port directional control valve as claimed in claim 10, wherein the first adjustable valve body is between the first valve chamber and the second valve chamber.

12. The 3-port directional control valve as claimed in claim 11, wherein the second adjustable valve body is between the second valve chamber and the third valve chamber.

13. The 3-port directional control valve as claimed in claim 7, wherein the first adjustable valve body has a first adjustment path and the second adjustable valve body has a second adjustment path, wherein the first and second adjustment path are parallel to each other.

14. The 3-port directional control valve as claimed in claim 7, wherein the axis of rotation lies between the first valve body and the second valve body.

15. The 3-port directional control valve as claimed in claim 7, further comprising a further axes of rotation, wherein the axes of rotation lie at a connection point of the relevant valve body and the actuation element respectively.

16. The 3-port directional control valve as claimed in claim 7, further comprising a spring element to exert a force on at least one valve body in a closing direction of the valve body, wherein the spring element is separated from the valve chambers by a separator.

17. The 3-port directional control valve as claimed in claim 7, wherein the spring element affects the first valve body and a further spring element affects the second valve body.

18. The 3-port directional control valve as claimed in claim 16, wherein an effective surface of the separator element is tailored to the effective cross section of the respective valve body.

19. The 3-port directional control valve as claimed in claim 16, wherein a first membrane is a wall of the third valve chamber.

20. The 3-port directional control valve as claimed in claim 19, wherein a second membrane is a wall of the first valve chamber.

21. The 3-port directional control valve as claimed in claim 19, wherein a second membrane is a wall of the second valve chamber.

22. The 3-port directional control valve as claimed in claim 19, wherein the second valve body extends through the first membrane and forms a tight seal with the first membrane.

23. The 3-port directional control valve as claimed in claim 22, wherein the first valve body extends through a second membrane forming a wall and forms a tight seal with the second membrane.
